(19) United States
(12) Patent Application Publication
(10) Pub. No.: US 2026/0226253 A1
(43) Pub. Date: Aug. 6, 2026

(54) ORGANIC ADDITIVES TO REDUCE THE COEFFICIENT OF THERMAL EXPANSION OF POLYMER COMPOSITIONS

(71) Applicant: National Technology & Engineering Solutions of Sandia, LLC, Albuquerque, NM (US)

(72) Inventors: Erica M. Redline, Albuquerque, NM (US); Eric M. Nagel, Albuquerque, NM (US); Alex J. Commisso, Farmington, NY (US); Chad Staiger, Albuquerque, NM (US)

(21) Appl. No.: 19/463,792

(22) Filed: Jan. 29, 2026

Related U.S. Application Data
(60) Provisional application No. 63/753,087, filed on Feb. 3, 2025.

(51) Int. Cl. C08K 5/156

(52) U.S. Cl. CPC C08K 5/156

(57) ABSTRACT

In aspects, a polymer composition includes a thermoset or thermoplastic polymer and an additive comprising a thermally contractile heterocyclic organic molecule having a coefficient of thermal expansion (CTE) that is less than the CTE of the thermoset or thermoplastic polymer.

### CROSS-REFERENCE TO RELATED APPLICATIONS

The present application claims the benefit of U.S. Provisional Patent Application Ser. No. 63/753,087, filed Feb. 3, 2025, entitled “ORGANIC ADDITIVES TO REDUCE THE COEFFICIENT OF THERMAL EXPANSION OF POLYMER COMPOSITIONS,” the entire teachings of which application is hereby incorporated herein by reference.

### STATEMENT OF GOVERNMENTAL INTEREST

This invention was made with Government support under Contract No. DE-NA0003525 awarded by the United States Department of Energy/National Nuclear Security Administration. The U.S. Government has certain rights in the invention.

### FIELD OF INVENTION

The present invention relates to polymer compositions and in particular to polymer compositions having thermally contractile organic additives and related methods.

### BACKGROUND

Polymers are low weight, low-cost, high-performance materials with excellent chemical, thermal, and mechanical stability. In addition to their use in homogenous components, polymers are frequently employed in combination with other materials, acting as adhesives, encapsulants, composite matrices, or barriers. In these cases, additional practical constraints are imposed upon the resulting composite materials, including the need to closely match the thermal expansion behaviors of the various constituents to achieve optimal performance.

Most solid materials experience positive thermal expansion upon heating, and the degree and rate at which this expansion occurs is referred to as the coefficient of thermal expansion (CTE). Bulk polymers typically possess large, positive CTEs in comparison to other materials. For example, a representative CTE value of a cured epoxy is approximately 55 ppm/° C., whereas common inorganic fillers such as silica or alumina possess CTE values of approximately 6 ppm/° C. and approximately 8 ppm/° C., respectively. In composites or devices, large differences in CTE between materials leads to CTE mismatch, causing internal thermomechanical stresses that may reduce reliability, the service life of the component and, in some cases, result in catastrophic device failure. Fluoroelastomers and rubbers used in high temperature applications, such as seals for geothermal, oil, and gas applications, can also suffer from CTE issues. As such, fine-tuning of polymer CTE represents a significant scientific challenge of interest to a variety of industries.

One strategy to address CTE mismatch is to covalently bond a low or negative CTE moiety into the backbone of the polymers in the matrix. However, incorporating these low/negative CTE moieties into the backbone of the polymer can introduce complexity into the method for synthesizing the polymer matrix, which may substantially increase the time and expense of manufacturing.

An alternative strategy to address CTE mismatch is to incorporate negative thermal expansion (NTE) inorganic materials as fillers within the polymer matrix. Such fillers act to depress the overall CTE of the composite. Inorganic compounds such as ZrW₂O₈ (CTE of approximately −9 ppm/° C.), or GaNMn₃ (CTEs as low as −70 ppm/° C.), have been explored for this purpose, allowing for the CTE of their respective composites to be modulated over an order of magnitude depending on filler loading. However, despite their promise, such composite materials are typically limited in their useful CTE window to sub-ambient temperatures. Moreover, high loadings of inorganic fillers are often required (80-90 wt. %) to significantly reduce CTE values, which can hinder material processing, add weight, and dramatically alter morphology and mechanical performance.

Accordingly, there is a need for low/negative CTE moieties that can be incorporated into polymer compositions without covalently attaching the CTE moieties to the polymer backbone, wherein the addition of the low/negative CTE moieties is effective at fine-tuning of the CTE of the polymer composition without having a significant impact on the material processing, morphology, and mechanical performance of the polymer composition.

### SUMMARY OF THE DISCLOSURE

The following is a brief summary of subject matter that is described in greater detail herein. This summary is not intended to be limiting as to the scope of the claims.

According to a first aspect of the present disclosure, a polymer composition comprises a thermoset or thermoplastic polymer and an additive comprising a molecule having a structure selected from the group consisting of:

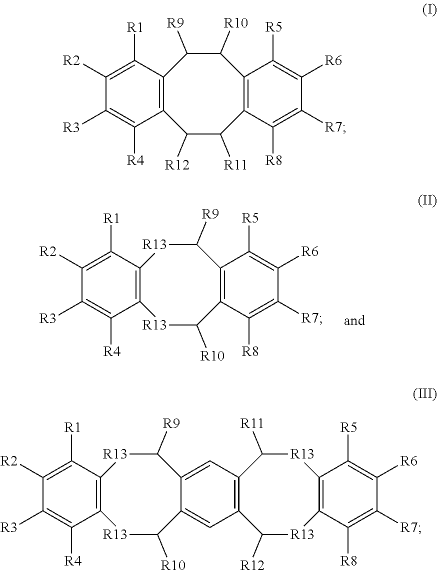

wherein:
R1-12 may be selected from the group including vinyl, methacrylate, acrylate, carboxylic acid, alcohol, amine, amide, cyanate, or other functional group or short chain polymer that provides chemical compatibility or chain entanglement to facilitate incorporation into the host polymer matrix without gross, macro-phase separation; R13 may be selected from the group oxygen, nitrogen, sulfur and methylene, wherein the polymer composition with these groups has a coefficient of thermal expansion (CTE) that is less than a coefficient of thermal expansion of the base thermoset or thermoplastic polymer.

According to a second aspect of the present disclosure, a polymer composition comprises the polymer composition of the first aspect, wherein at least three of R1, R2, R3, and R4 are hydrogen, and wherein at least three of R5, R6, R7, and R8 are hydrogen. The member(s) of the group R1-R4 that are not hydrogen are selected from the group including vinyl, methacrylate, acrylate, carboxylic acid, alcohol, amine, amide, cyanate, or other functional group or short chain polymer that facilitates incorporation into the host polymer matrix without gross macro-phase separation.

According to a third aspect of the present disclosure, a polymer composition comprises the polymer composition of the first or second aspect, wherein one of R1, R2, R3, or R4 is not hydrogen, and one of R5, R6, R7, or R8 is not hydrogen, but are selected from a group including vinyl, methacrylate, acrylate, carboxylic acid, alcohol, amine, amide, cyanate, or other functional group or short chain polymer that provides chemical compatibility or chain entanglement to facilitate incorporation into the host polymer matrix without gross, macro-phase separation.

According to a fourth aspect of the present disclosure, a polymer composition comprises the polymer composition of any of the previous aspects, wherein each of R9, R10, R11, and R12 is hydrogen.

According to a fifth aspect of the present disclosure, a polymer composition comprises the polymer composition of the first to third aspects, wherein at least one of R9, R10, R11, or R12 is not hydrogen.

According to a sixth aspect of the present disclosure, a polymer composition comprises the polymer composition of any of the previous aspects, wherein R13 is oxygen.

According to a seventh aspect of the present disclosure, a polymer composition comprises the polymer composition of any of the previous aspects, wherein the additive comprises a monosubstituted- or disubstituted-dibenzocylooctane.

According to an eighth aspect of the present disclosure, a polymer composition comprises the polymer composition of any of the first to sixth aspects, wherein the additive comprises a monosubstituted- or disubstituted-dibenzo-1,4-dioxocane.

According to a ninth aspect of the present disclosure, a polymer composition comprises the polymer composition of any of the first to sixth aspects, wherein the additive comprises a monosubstituted- or disubstituted bisdibenzo-1,4-dioxocane.

According to a tenth aspect of the present disclosure, a polymer composition comprises the polymer composition of any of the previous aspects, wherein one or more of: (1) R1, R2, R3, or R4 and (2) R5, R6, R7, or R8 of the additive is entangled with the thermoset or thermoplastic polymer.

According to an eleventh aspect of the present disclosure, a polymer composition comprises the polymer composition of any of the previous aspects, wherein the additive is present in an amount of from about 5 wt. % to about 50 wt. %, based on the total weight of the polymer composition.

According to a twelfth aspect of the present disclosure, a polymer composition comprises the polymer composition of any of the previous aspects, wherein one or more of: (1) R1, R2, R3, or R4 and (2) R5, R6, R7, or R8 is selected from the group consisting of a polystyrene, a polyolefin, a polyurethane, a polyester, a polyamide, a polyimide, and a polyepoxide.

According to a thirteenth aspect of the present disclosure, a method of preparing a polymer composition comprises: blending a thermoset or thermoplastic polymer with an additive having a low or negative coefficient of thermal expansion (CTE), wherein the additive comprises a molecule having a structure selected from the group consisting of:

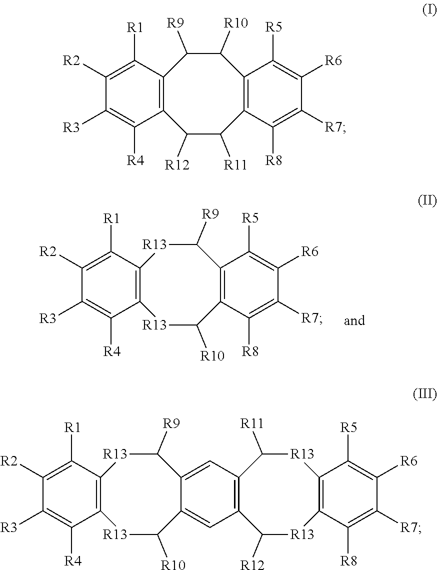

wherein R13 is selected from the group consisting of oxygen, nitrogen, and sulfur.

According to a fourteenth aspect of the present disclosure, a method of preparing a polymer composition comprises the method according to the thirteenth aspect, wherein at least three of R1, R2, R3, and R4 are hydrogen, and wherein at least three of R5, R6, R7, and R8 are hydrogen.

According to a fifteenth aspect of the present disclosure, a method of preparing a polymer composition comprises the method according to the thirteenth or fourteenth aspect, wherein the blending comprises using a solvent blending method.

According to a sixteenth aspect of the present disclosure, a method of preparing a polymer composition comprises the method according to the thirteenth or fourteenth aspect, wherein the blending comprises extruding, heated extrusion, melt blending, or roll milling.

According to a seventeenth aspect of the present disclosure, a method of preparing a polymer composition comprises the method according to any of the thirteenth to sixteenth aspects, wherein one of R1, R2, R3, or R4 is not hydrogen, and one of R5, R6, R7, or R8 is not hydrogen.

According to an eighteenth aspect of the present disclosure, a method of preparing a polymer composition comprises the method according to any of the thirteenth to the seventeenth aspects, wherein each of R9, R10, R11, and R12 is hydrogen.

According to a nineteenth aspect of the present disclosure, a method of preparing a polymer composition comprises the method according to any of the thirteenth to the seventeenth aspects, wherein at least one of R9, R10, R11, or R12 is not hydrogen.

According to a twentieth aspect of the present disclosure, a method of preparing a polymer composition comprises the method according to any of the thirteenth to the nineteenth aspects, wherein R13 is oxygen.

According to a twenty-first aspect of the present disclosure, a method of preparing a polymer composition comprises the method according to any of the thirteenth to the twentieth aspects, wherein the additive comprises a monosubstituted- or disubstituted-dibenzocylooctane.

According to a twenty-second aspect of the present disclosure, a method of preparing a polymer composition comprises the method according to the twenty-first aspect, wherein the blending comprises adding to the thermoset or thermoplastic polymer a precursor of the additive, wherein the precursor dimerizes during the blending to form the additive.

According to a twenty-third aspect of the present disclosure, a method of preparing a polymer composition comprises the method according to the twenty-second aspect, wherein the precursor comprises a substituted benzocylcobutene.

According to a twenty-fourth aspect of the present disclosure, a method of preparing a polymer composition comprises the method according to any of the thirteenth to the twentieth aspects, wherein the additive comprises a monosubstituted- or disubstituted-dibenzo-1,4-dioxocane.

According to a twenty-fifth aspect of the present disclosure, a method of preparing a polymer composition comprises the method according to any of the thirteenth to the twentieth aspects, wherein the additive comprises a monosubstituted- or disubstituted bisdibenzo-1,4-dioxocane.

According to a twenty-sixth aspect of the present disclosure, a method of preparing a polymer composition comprises the method according to any of the thirteenth to twenty-fifth aspects, wherein one or more of: (1) R1, R2, R3, or R4 and (2) R5, R6, R7, or R8 of the additive is entangled with the thermoset or thermoplastic polymer.

According to a twenty-seventh aspect of the present disclosure, a method of preparing a polymer composition comprises the method according to any of the thirteenth to twenty-sixth aspects, wherein the additive is present in an amount of from about 5 wt. % to about 50 wt. %, based on the total weight of the polymer composition.

According to a twenty-eighth aspect of the present disclosure, a method of preparing a polymer composition comprises the method according to any of the thirteenth to the twenty-seventh aspects, wherein at least one of: (1) R1, R2, R3, or R4 and (2) R5, R6, R7, or R8 has an entanglement weight that is within ±10% of an entanglement weight of the thermoset or thermoplastic polymer.

According to a twenty-ninth aspect of the present disclosure, a method of preparing a polymer composition comprises the method according to any of the thirteenth to twenty-eighth aspects, wherein at least one of: (1) R1, R2, R3, or R4 and (2) R5, R6, R7, or R8 is configured to hydrogen bond with the thermoset or thermoplastic polymer.

According to a thirtieth aspect of the present disclosure, a method of preparing a polymer composition comprises the method according to any of the thirteenth to the twenty-ninth aspects, wherein at least one of: (1) R1, R2, R3, or R4 and (2) R5, R6, R7, or R8 is selected from the group consisting of a polystyrene, a polyolefin, a polyurethane, a polyester, a polyamide, a polyimide, and a polyepoxide.

The above summary presents a simplified summary in order to provide a basic understanding of some aspects of the compositions and/or methods discussed herein. This summary is not an extensive overview of the compositions and/or methods discussed herein. It is not intended to identify key/critical elements or to delineate the scope of such compositions and/or methods. Its sole purpose is to present some concepts in a simplified form as a prelude to the more detailed description that is presented later.

### BRIEF DESCRIPTION OF THE DRAWINGS

FIG. 1 is a schematic illustration of thermally controlled isomerization of DBCO between twist-boat and chair conformers.

FIG. 2A shows a synthetic route to prepare a dihydroxy-dibenzocyclooctane and a diazido-DBCO. FIG. 2B shows a synthetic route to prepare a dicarboxylic acid-substituted DBCO and a dianhydride-DBCO. FIG. 2C shows an ortho, ortho-cis-diamino version of tetramethylated dibenzocyclooctane.

FIG. 3 is a schematic illustration of the molecular volume decrease u-boat to s-boat isomerization of bisdibenzo-1,4-dioxocane.

FIG. 4A shows an exemplary dimerization reaction of BCB to prepare DBCO. FIG. 4B shows a dimerization reaction of BCB with a substituent on the four-membered ring to prepare DBCO. FIG. 4C shows an exemplary dimerization reaction of BCB with a first substituent on the four-membered ring and a second substituent on the benzene ring to prepare DBCO.

FIG. 5 is an illustration of a method to synthesize polystyrene-DBCO from BCB with an alkene substituent on the benzene ring.

FIG. 6A is an illustration of a method to synthesize BCB. FIG. 6B is an illustration of a method to synthesize a BCB and, subsequently, di-amino DBCO.

FIG. 7 is a schematic of an exemplary polymerization process for synthesizing a DBCO-based additive in situ during an extrusion process.

FIG. 8A shows a synthetic route to prepare DADBCO. FIG. 8B shows a second synthetic route to DADBCO.

FIG. 9 is a schematic illustration of the molecular volume decrease during twist-boat to chair isomerization of DADBCO.

FIG. 10 shows a synthetic route to dicarboxy-DBCO.

FIGS. 11A-11C show exemplary synthetic routes to 2,2′-diamino-dibenzo[b,f][1,4]dioxocin and 2,3′-diamino[b,f][1,4]dioxocin.

FIG. 12A is an illustration of a method to synthesize polyamide-substituted dibenzo-1,4-dioxocane. FIG. 12B is an illustration of a method to synthesize polyamide-substituted bisdibenzo-1,4-dioxocane.

FIG. 13 shows an exemplary synthetic route to bisdibenzo-1,4-dioxocane.

FIG. 14 is a graph showing the DBCO yield percent in BCB dimerization as a function of conversion temperature upon addition of radical polymerization inhibitors.

FIGS. 15A and 15B show the modeling results of various diamine heterocyclic molecules in an epoxy resin that to predict their thermodynamic and volume changes at 25° C. and 200° C.

### DETAILED DESCRIPTION

Various technologies pertaining to organic additives to reduce the CTE of polymer compositions and related methods are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

### Definitions and Abbreviations

To further facilitate an understanding of the present disclosure, a number of terms and phrases are defined below. Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Ranges provided herein are understood to be shorthand for all of the values within the range. For example, a range of 1 to 25 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, or 25, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 25 may comprise 1 to 5, 1 to 10, 1 to 15, and 1 to 20 in one direction, or 25 to 20, 25 to 15, 25 to 10, and 25 to 5 in the other direction.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, as used herein, the term “exemplary” is intended to mean serving as an illustration or example of something and is not intended to indicate a preference.

The abbreviation “CTE” as used herein is an abbreviation for the term “coefficient of thermal expansion.” The coefficient of thermal expansion is a measure of how the size of an object changes with a change in temperature. It is calculated by the fractional change in size per degree change in temperature, typically at a constant pressure, such that a lower CTE represents a material with a lower propensity for change in size upon change in temperature. CTEs may be determined for volumetric, area, and/or linear changes in size of a given object.

The abbreviation “DBCO” as used herein is an abbreviation for the term “dibenzocyclooctane” (also referred to as “dibenzocyclooctene”) and derivatives thereof. The molecular structure of DBCO is displayed below.

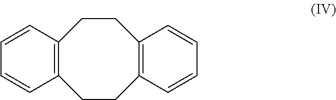 [SMILES: c1ccc2c(c1)CCc1ccccc1CC2]

The abbreviation “DADBCO” as used herein is an abbreviation for the term “diamino-dibenzocyclooctane” and derivatives thereof. The molecular structure of DADBCO is displayed below.

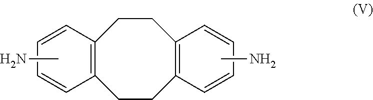

The abbreviation “BCB” as used herein is an abbreviation for the term “benzocyclobutene” and derivatives thereof. The molecular structure of BCB is displayed below.

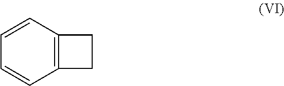

### Compositions

In general, a polymer composition according to the present disclosure comprises a thermoset or thermoplastic polymer and an additive. As will be described hereinbelow, the additive may be a thermally contractile additive. In various aspects, although the additive is present in the polymer composition and may entangle with the thermoset or thermoplastic polymer, the additive is not chemically bound to the polymer. Alternatively, the additive may function as a substrate for polymerization of the polymer such that the additive is present only near ends of the polymer chain. Accordingly, the additive is effective to reduce the CTE of the polymer composition as compared to the CTE of the thermoset or thermoplastic polymer while enabling the polymer composition to maintain properties of the thermoset or thermoplastic polymer such as the modulus, the glass transition temperature (T_{g}), and the like.

The thermoset or thermoplastic polymer generally comprises a host polymer chain selected from the group consisting of a polystyrene, a polyolefin, a polyurethane, a polyester, a polyamide, a polyimide, and a polyepoxide. In aspects, the additive is or includes a thermally contractile heterocyclic organic molecule having a CTE that is less than a coefficient of thermal expansion of the thermoset or thermoplastic polymer. The additive can comprise any heterocyclic organic molecule that can undergo an isomerization which is energetically favored to flip from a primary conformation (e.g., the conformation of the molecule at room temperature) to a secondary conformation at elevated temperatures in which the energetically favorable conformation has a smaller volume than the primary conformation, as will be described in greater detail hereinbelow. In various aspects, the additive is substituted with a substituent that is the same moiety as the host polymer chain. In aspects, the additive is substituted with a substituent that is an entanglement weight that is within ±10% of an entanglement weight of the thermoset or thermoplastic polymer. In aspects, at least one of the substituents on the additive is configured to hydrogen bond with the thermoset or thermoplastic polymer.

In aspects, the additive is present in an amount of from about 5 wt. % to about 50 wt. %, based on the total weight of the polymer composition. For example, the additive may be present in an amount of from about 1 wt. % to about 25 wt. %, or less than 10 wt. %, based on the total weight of the polymer composition.

In aspects, the additive comprises a molecule having a structure selected from the group consisting of:

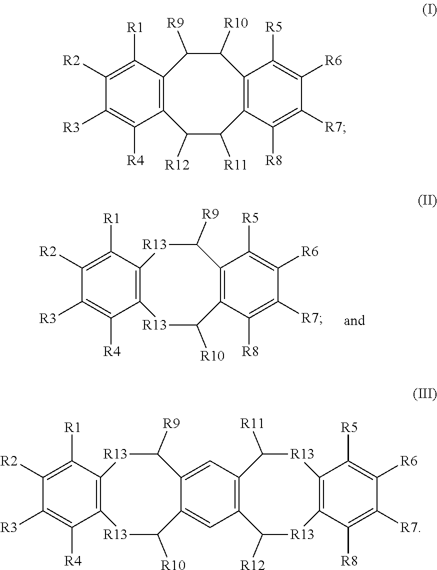

In aspects, R13 is selected from the group consisting of oxygen, nitrogen, sulfur and methylene. In aspects, R13 is oxygen.

In aspects, at least one of R9, R10, R11, or R12 is a moiety other than hydrogen. In aspects, two of R9, R10, R11, and R12 are hydrogen, and wherein the remaining two of R9, R10, R11, and R12 are a moiety other than hydrogen. In aspects, each of R9, R10, R11, and R12 is a moiety other than hydrogen. At least one of R9, R10, R11, and R12 comprise a primary amine (NH₂), an alcohol (OH), a secondary amide (NH(C═O)R′), or a ketone (C═O); or anyone of these groups attached to a short (C1-C3)alkane. In aspects, each of R9, R10, R11, and R12 comprise a primary amine (NH₂), an alcohol (OH), a secondary amide (NH(C═O)R′), or a ketone (C═O); or anyone of these groups attached to a short (C1-C3)alkane. In aspects, each of R9, R10, R11, and R12 is hydrogen.

In aspects, R1, R2, R3, and R4 are all hydrogen. In aspects, all of R5, R6, R7, and R8 are all hydrogen. In aspects, at least one of R1, R2, R3, or R4 is selected from the group consisting of: a polystyrene, a polyolefin, a polyurethane, a polyester, a polyamide, a polyimide, and a polyepoxide. Additionally, in some embodiments, at least one of R5, R6, R7, or R8 is selected from the group consisting of: a polystyrene, a polyolefin, a polyurethane, a polyester, a polyamide, a polyimide, and a polyepoxide. In aspects, three of R1, R2, R3, and R4 are hydrogen, and the remaining one of R1, R2, R3, or R4 is a moiety other than hydrogen. In aspects, three of R5, R6, R7, and R8 are hydrogen, and the remaining one of R5, R6, R7, or R8 is a moiety other than hydrogen. In aspects, more than one of R1, R2, R3, and R4 are a moiety other than hydrogen. In aspects, more than one of R4, R5, R6, and R7 are a moiety other than hydrogen. In aspects in which at least one of R1, R2, R3, or R4 is a moiety other than hydrogen, the moiety other than hydrogen may be entangled with and/or hydrogen bonded to the thermoset or thermoplastic polymer. In aspects in which at least one of R5, R6, R7, or R8 is a moiety other than H, the moiety other than hydrogen may be entangled with and/or hydrogen bonded to the thermoset or thermoplastic polymer.

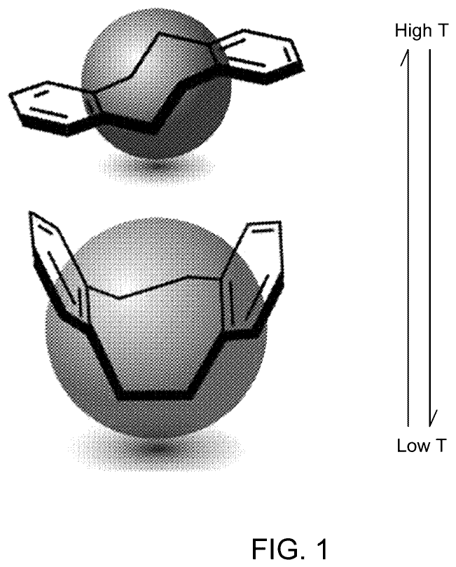

A strategy to manipulate the CTE of polymers involves incorporation of thermally contractile units within a polymer network. These “shrinking” linkages oppose thermal expansion during heating, with the net effect of reducing the CTE of the material to near or less than zero in some cases. As shown in FIG. 1, one such contractile group is DBCO, comprising a flexible cyclooctane ring connecting two rigid benzene groups which undergoes a reversible twist-boat to chair isomerization upon heating accompanied by a decrease in molecular volume. To date, DBCO has been covalently bonded to the backbone of various thermoplastic and thermoset polymers. Although covalently incorporating DBCO onto the backbone of the polymer can alter the CTE of the polymer composition, the use of DBCO derivatives as an additive in the polymer composition may enable greater ease of use, since the CTE reduction of the polymer can be achieved without the potential need to change the polymerization process.

In aspects, the additive comprises a DBCO derivative. The DBCO derivative comprises a cyclooctene ring fused to the aromatic end groups, thereby providing high conformational flexibility. The molecular structure of an exemplary DCBO molecule with R1-R12 substituents is shown below.

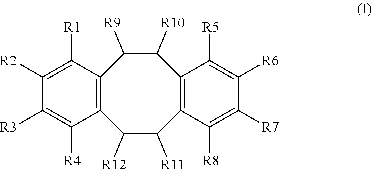

In aspects, the additive of the polymer composition comprises a monosubstituted DBCO. In aspects, the additive of the polymer composition comprises a disubstituted DBCO. In aspects, the disubstituted DBCO comprises a cis isomer such as a 1,1′-disubstituted DBCO, a 2,2′-disubstituted DBCO, a 3,3′-disubstituted DBCO, a 4,4′-disubstituted DBCO, a 1,2′-disubstituted DBCO, a 2,1′-disubstituted DBCO, a 3,4′-disubstituted DBCO, or a 4,3′-disubstituted DBCO. In aspects, the disubstituted DBCO comprises a trans isomer such as a 1,3′-disubstituted DBCO, a 1,4′-disubstituted DBCO, a 2,3′-disubstituted DBCO, a 2,4′-disubstituted DBCO, 3,1′-disubstituted DBCO, a 3,2′-disubstituted DBCO, a 4,1′-disubstituted DBCO, or a 4,2′-disubstituted DBCO. The molecular structure of an exemplary 2,2′-di(polystyrene)-DBCO (VII) is shown below.

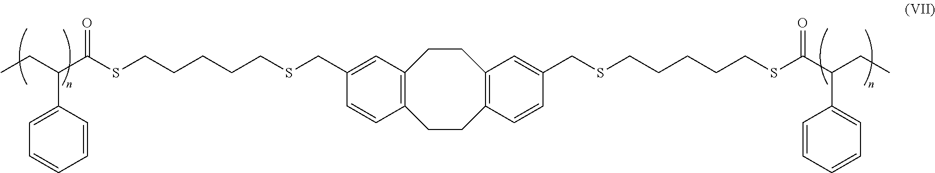

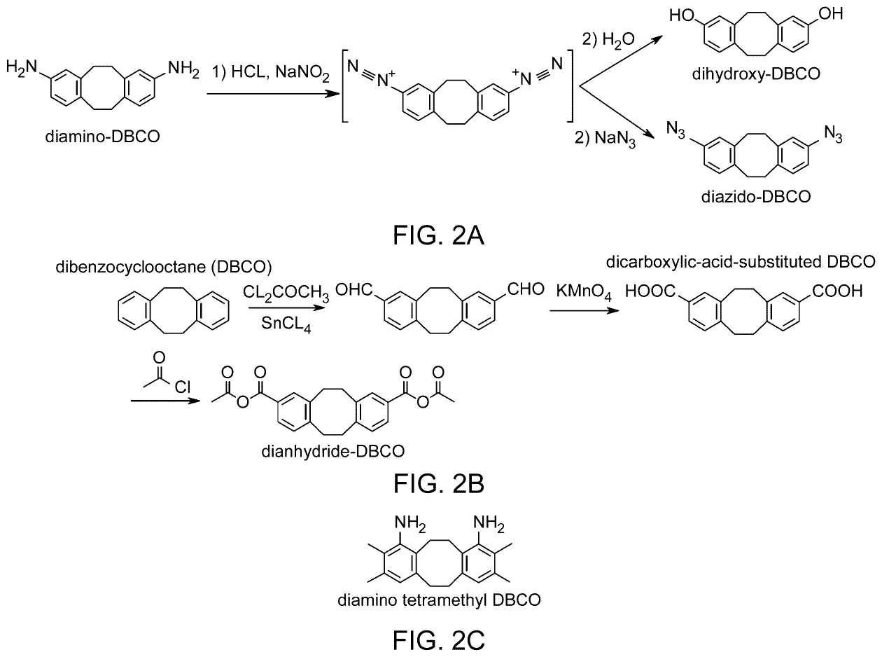

The phenyl rings of a monosubstituted or disubstituted DBCO can be further substituted (i.e., at R1, R2, R3, R4, R5, R6, R7, and/or R8) with one or more alkyl groups such that the molecule can still undergo reversible twist-boat to chair isomerization. FIG. 2C shows an exemplary ortho-ortho-cis diamino version of tetramethylated DBCO.

In aspects, the additive comprises a molecule having the below structure:

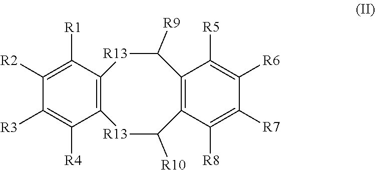

Molecule II comprises a cyclooctene ring with [b,f]heterogroups (R13), wherein the cyclooctene ring is fused to the aromatic end groups, thereby providing high conformational flexibility. In aspects, the additive comprises a dibenzo-1,4-dioxocane derivative (i.e., wherein R13 is oxygen). The molecular structure of an exemplary dibenzo-1,4-dioxocane molecule with R1-R10 and R13 substituents is shown below.

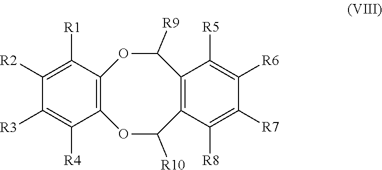

In aspects, the additive of the polymer composition comprises a monosubstituted dibenzo-1,4-dioxocane. In aspects, the additive of the polymer composition comprises a disubstituted dibenzo-1,4-dioxocane. In aspects, the disubstituted dibenzo-1,4-dioxocane comprises a cis isomer such as a 1,1′-disubstituted dibenzo-1,4-dioxocane, a 2,2′-disubstituted dibenzo-1,4-dioxocane, a 3,3′-disubstituted dibenzo-1,4-dioxocane, a 4,4′-disubstituted dibenzo-1,4-dioxocane, a 1,2′-disubstituted dibenzo-1,4-dioxocane, a 2,1′-disubstituted dibenzo-1,4-dioxocane, a 3,4′-disubstituted dibenzo-1,4-dioxocane, or a 4,3′-disubstituted dibenzo-1,4-dioxocane. In aspects, the disubstituted dibenzo-1,4-dioxocane comprises a trans isomer such as a 1,3′-disubstituted dibenzo-1,4-dioxocane, a 1,4′-disubstituted dibenzo-1,4-dioxocane, a 2,3′-disubstituted dibenzo-1,4-dioxocane, a 2,4′-disubstituted dibenzo-1,4-dioxocane, 3,1′-disubstituted dibenzo-1,4-dioxocane, a 3,2′-disubstituted dibenzo-1,4-dioxocane, a 4,1′-disubstituted dibenzo-1,4-dioxocane, or a 4,2′-disubstituted dibenzo-1,4-dioxocane. The molecule structure of an exemplary 2,2′-polyamide-dibenzo[b,f][1,4]dioxocin (IX) is shown below.

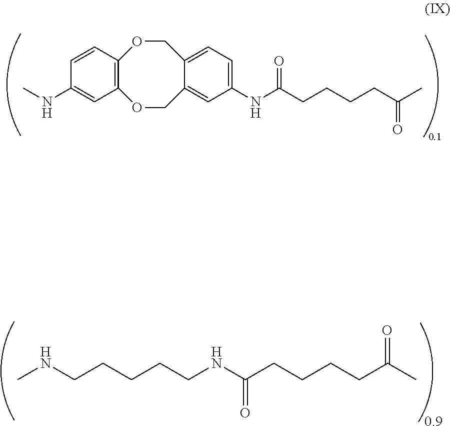

The phenyl rings of a monosubstituted or disubstituted dibenzo-1,4-dioxocane (i.e., at R1, R2, R3, R4, R5, R6, R7, and/or R8) can be further substituted with one or more alkyl groups such that the molecule can still undergo reversible twist-boat to chair isomerization.

In aspects, the additive comprises a molecule having the below structure:

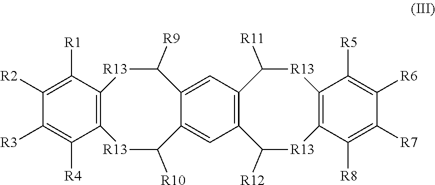

Molecule III comprises two cyclooctene rings with [b,f]heterogroups (R13), wherein each cyclooctene ring is fused to the aromatic end groups as well as a central benzene ring, thereby providing high conformational flexibility. In aspects, the additive comprises a bisdibenzo-1,4-dioxocane derivative (i.e., wherein R13 is oxygen). The molecular structure of an exemplary bisdibenzo-1,4-dioxocane molecule with R1-R13 substituents is shown below.

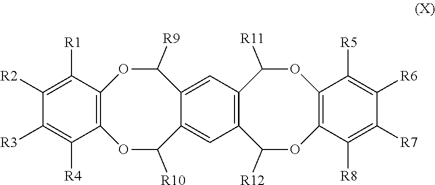

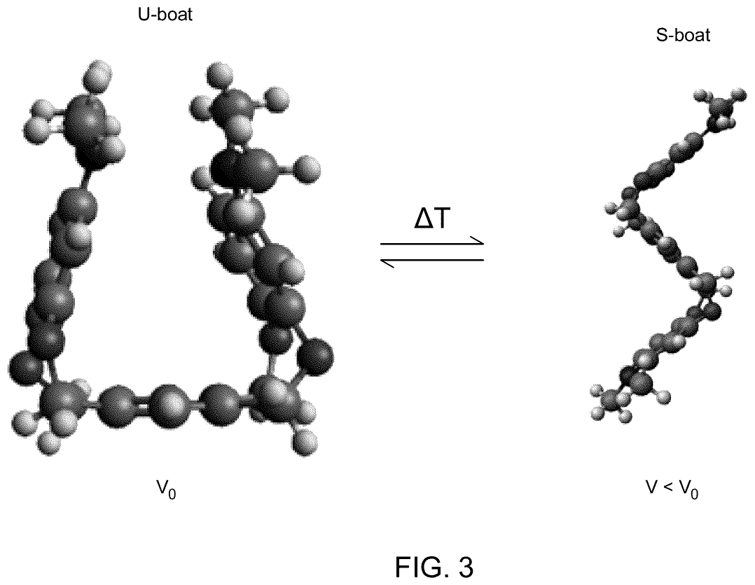

FIG. 3 shows the thermodynamics of the u-boat to s-boat transition for an exemplary bisdibenzo-1,4-dioxocane derivative, in which the molecular volume decreases upon this isomerization when heat is added to the system.

In aspects, the additive of the polymer composition comprises a monosubstituted bisdibenzo-1,4-dioxocane. In aspects, the additive of the polymer composition comprises a disubstituted bisdibenzo-1,4-dioxocane. In aspects, the disubstituted bisdibenzo-1,4-dioxocane comprises a cis isomer such as a 1,1′-disubstituted bisdibenzo-1,4-dioxocane, a 2,2′-disubstituted bisdibenzo-1,4-dioxocane, a 3,3′-disubstituted bisdibenzo-1,4-dioxocane, a 4,4′-disubstituted bisdibenzo-1,4-dioxocane, a 1,2′-disubstituted bisdibenzo-1,4-dioxocane, a 2,1′-disubstituted bisdibenzo-1,4-dioxocane, a 3,4′-disubstituted bisdibenzo-1,4-dioxocane, or a 4,3′-disubstituted bisdibenzo-1,4-dioxocane. In aspects, the disubstituted bisdibenzo-1,4-dioxocane comprises a trans isomer such as a 1,3′-disubstituted bisdibenzo-1,4-dioxocane, a 1,4′-disubstituted bisdibenzo-1,4-dioxocane, a 2,3′-disubstituted bisdibenzo-1,4-dioxocane, a 2,4′-disubstituted bisdibenzo-1,4-dioxocane, 3,1′-disubstituted bisdibenzo-1,4-dioxocane, a 3,2′-disubstituted bisdibenzo-1,4-dioxocane, a 4,1′-disubstituted bisdibenzo-1,4-dioxocane, or a 4,2′-disubstituted bisdibenzo-1,4-dioxocane. The molecular structure of an exemplary 2,2′-dipolyamide-bisdibenzo-1,4-dioxocane (XI) molecule is shown below.

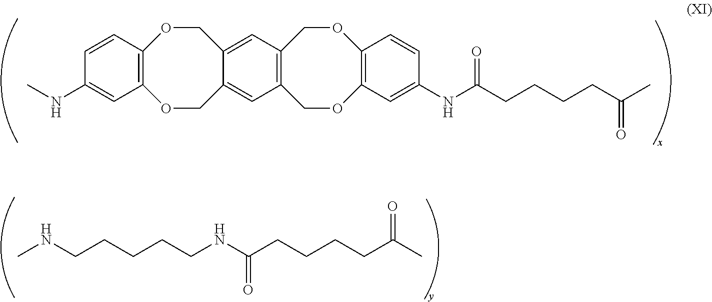

The phenyl rings of a monosubstituted or disubstituted bisdibenzo-1,4-dioxocane (i.e., at R1, R2, R3, R4, R5, R6, R7, and/or R8) can be further substituted with one or more alkyl groups such that the molecule can still undergo reversible u-boat to s-boat isomerization.

### Methods of Preparing DBCO Molecules

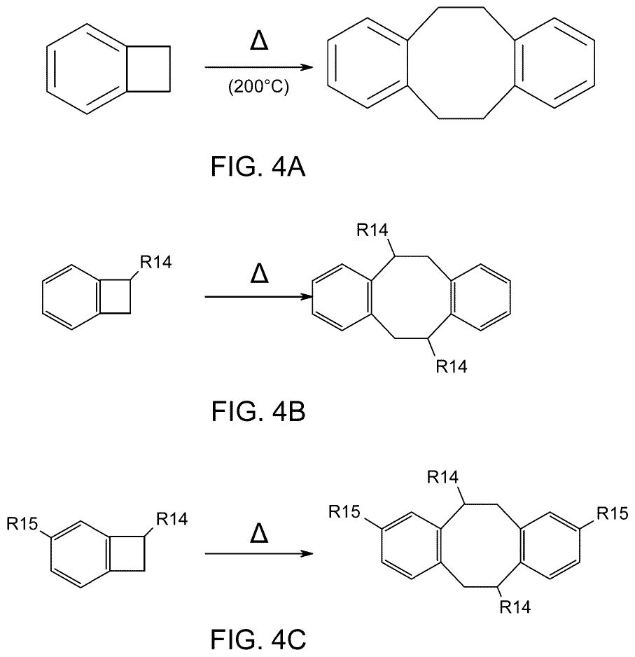

In aspects, BCBs can serve as precursors to DBCOs in the preparation of low CTE additives. As shown in FIG. 4A, BCBs undergo a 2+2 cyclization upon heating to form a 1,5-cyclooctadiene (DBCO) ring. However, this 2+2 cyclization of BCB requires high temperatures (e.g., approximately 200° C.) and results in a low yield of the DBCO dimer, including production of unidentified oligomeric products. Thus, a reaction that favors dimerization over oligomerization reactions and involves a reduced reaction temperature is desired.

In aspects, BCBs used to produce DBCOs have a substituent (R14) on the four-membered ring. Adding substituents to the four-membered ring of BCBs may reduce the cure temperature needed to produce DBCOs via dimerization (e.g., 25-150° C.). An exemplary dimerization reaction of a BCB with a substituent (R14) on the four-membered ring to produce a DBCO is shown in FIG. 4B. The molecular structure of an exemplary BCB molecule with a substituent on the 4-membered ring (XII) is shown below.

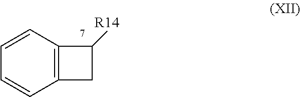

In aspects, the dimerization of BCBs that have a substituent on the four-membered ring to produce DBCOs takes place at a temperature of 150° C. or less or 120° C. or less. For example, the temperature may be from 25° C. to 150° C., from 80° C. to 120° C., or from 90° C. to 120° C.

In some aspects, the BCBs used to produce DBCOs have a first substituent (R14) on the four-membered ring and a second substituent (R15) on the benzene ring. An exemplary dimerization reaction of a BCB with a first substituent (R14) on the four-membered ring and a second substituent (R15) on the benzene ring to produce a DBCO is shown in FIG. 4C. The molecular structure of an exemplary BCB molecule with a first substituent (R14) on the 4-membered ring and a second substituent (R15) on the benzene ring (XIII) is shown below.

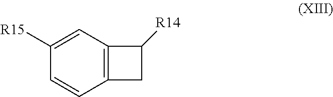

Although exemplary BCB molecule XI shows a substituent (R15) bound to the fourth carbon of the benzene ring, the R15 substituent can be bound to any of the carbons on the benzene ring that are not also in the four-membered ring (i.e., positions 2-5). The BCB molecule may be substituted at more than one location the benzene ring on carbons that are not also in the four-membered ring.

In aspects, the BCBs used to produce DBCOs may have an additional substituent (R16) on the four-membered ring, as shown below:

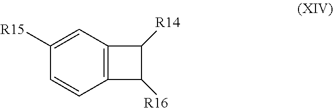

In aspects, the R14 BCB substituent on the four-membered ring comprises a hydrogen, a primary amine (NH₂), an alcohol (OH), a secondary amide (NH(C═O)R′), or a ketone (C═O); or anyone of these groups attached to a short (C1-C3)alkane. In aspects, the R14 substituents on both BCB reactants in the BCB dimerization reaction to produce DBCO are the same. In aspects, the R16 BCB substituent on the four-membered ring comprises a hydrogen, a primary amine (NH₂), an alcohol (OH), a secondary amide (NH(C═O)R′), or a ketone (C═O); or anyone of these groups attached to a short (C1-C3)alkane. In aspects, the R16 substituents on both BCB reactants in the BCB dimerization reaction to produce DBCO are the same. In aspects, the R14 and R16 substituents comprise the same moieties. In aspects, the R14 and R16 substituents comprise different moieties.

In aspects, the R15 BCB substituent on the benzene ring is a polymer. In aspects, the R15 BCB substituent on the benzene ring is selected from the group consisting of a polystyrene, a polyolefin, a polyurethane, a polyester, a polyamide, and a polyimide. In aspects, the R15 BCB substituent comprises a reactive moiety, which is then used as the reaction site for the addition of a polymer. In aspects, this reactive moiety comprises an alcohol, a primary or secondary amine, a thiol, an alkene, an alkyne, a carbonyl, a carboxylic acid, or an alkyl halide. In aspects, the R15 substituents on both BCB reactants in the BCB dimerization reaction to produce DBCO are the same.

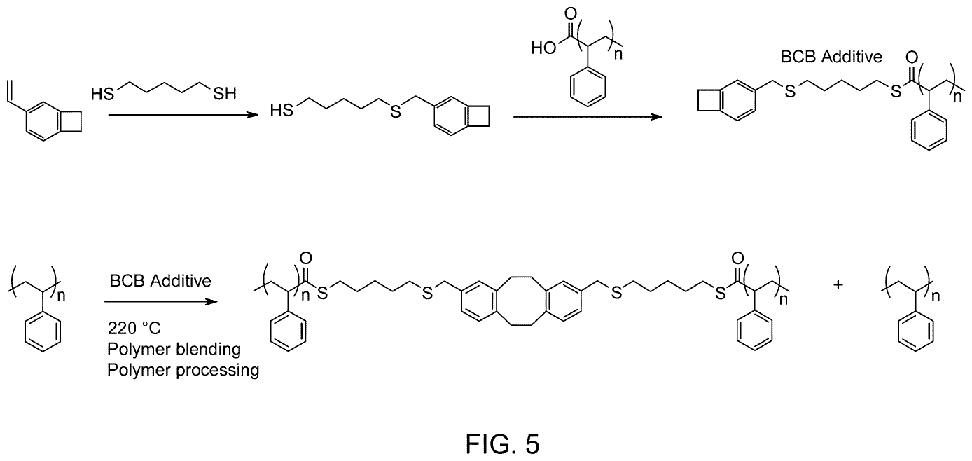

FIG. 5 depicts an exemplary dimerization process beginning with a BCB with an alkene moiety at R15, which then undergoes reactions to add a polystyrene moiety to form a BCB additive intermediate. This BCB additive intermediate is then reacted with additional polystyrene and BCB additive intermediate under heat, which undergoes polymer blending and processing, to produce a DBCO having polystyrene moieties.

A radical polymerization inhibitor may be used in the BCB dimerization reaction to produce DBCO. Radical polymerization inhibitors can include, by way of example and not limitation, (2,2,6,6-tetramethylpiperidin-1-yl)oxyl (TEMPO), butylated hydroxytoluene (BHT), and mequinol (MeHQ). Such radical polymerization inhibitors may be used at a concentration of from greater than 0 mol. % to about 5 mol. %.

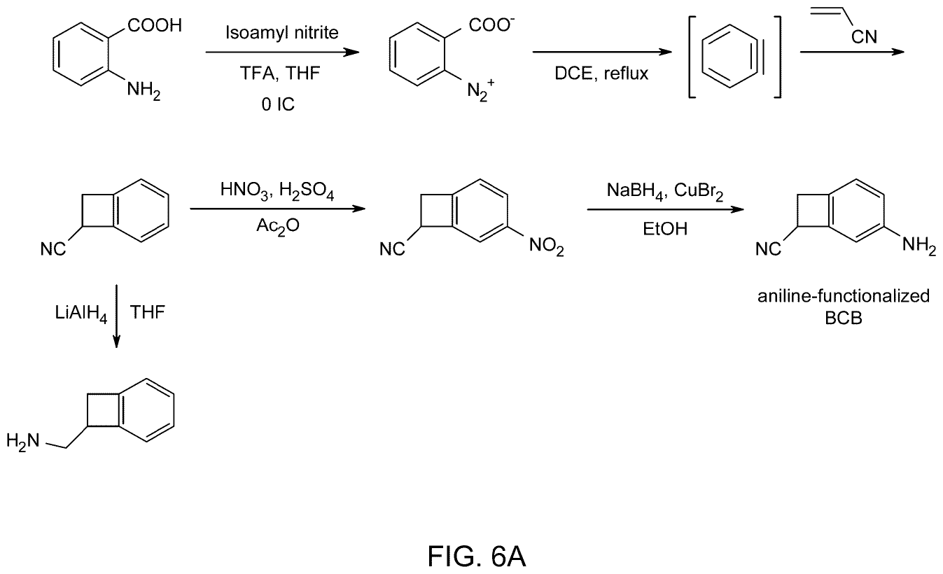

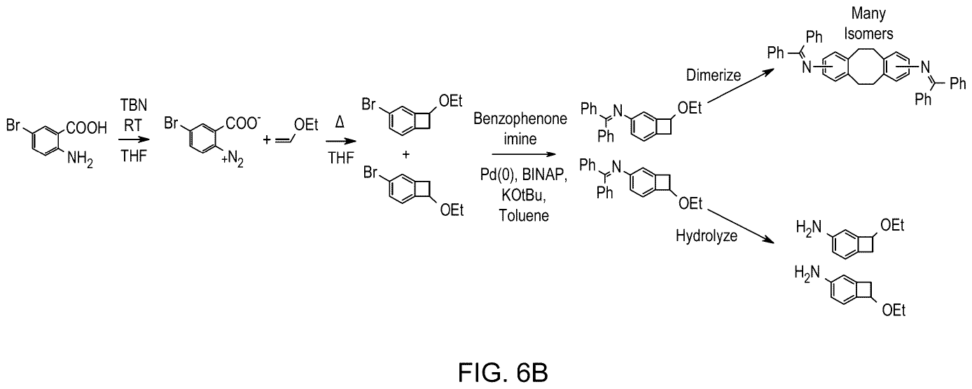

BCB may be synthesized from commercially available chemicals. As shown in FIG. 6A, an aniline-functionalized BCB can be synthesized in three discreet steps from anthranilic acid. In the first step, anthranilic acid is converted to the corresponding benzenediazonium salt using isoamyl nitrite catalyzed by trifluoroacetic acid (TFA) in tetrahydrofuran (THF) at 0° C. The resulting precipitate is then filtered very carefully, as this compound can be high energetic and may cause an explosion if not kept wet. After filtration, the precipitate is then thoroughly washed with dichloroethane (DCE). The solids are subsequently resuspended in dichloroethane, acrylonitrile is added, and 1-cyanobenzocyclobutene is then prepared via cycloaddition with acrylonitrile. Nitration of 1-cyanobenzocyclobutene with HNO₃ in the presence of catalytic H₂SO₄ and acetic anhydride as the solvent gives the 2-nitro product selectively, which is reduced to the 2-aniline-functionalized BCB using NaBH₄ and a Cu(II)Br₂ catalyst.

Alternatively, as shown in FIG. 6B, BCB may be synthesized via a process in which the first step comprises reaction of 2-amino-5-bromobenzoic acid with TBN and THF at room temperature to produce a benzene-based intermediate with a negatively charged carboxylate moiety and a reactive, positively charged diazonium moiety. This intermediate compound must be kept wet and handled carefully to avoid unintended energetic release (e.g., such as by an explosion). In the second step, ethoxy ethene is added to this highly reactive benzene intermediate under heat with THE to produce a BCB that has a bromine substituent on the benzene ring at R15 and an ethoxy substituent on the four-membered ring at R14. In the third step, benzophenone imine, palladium(0), 2,2′-bis(diphenylphosphino)-1,1′-binaphthyl (BINAP), potassium tert-butoxide, and toluene are added to this bromine- and ethoxy-substituted BCB to produce a BCB that has a benzophenone imine substituent on the benzene ring at R15 and an ethoxy substituent on the four-membered ring at R14. This BCB can then be dimerized to synthesize diamino-DBCO derivatives directly or can be incorporated into resins which are then cured to form diamino-DBCO units.

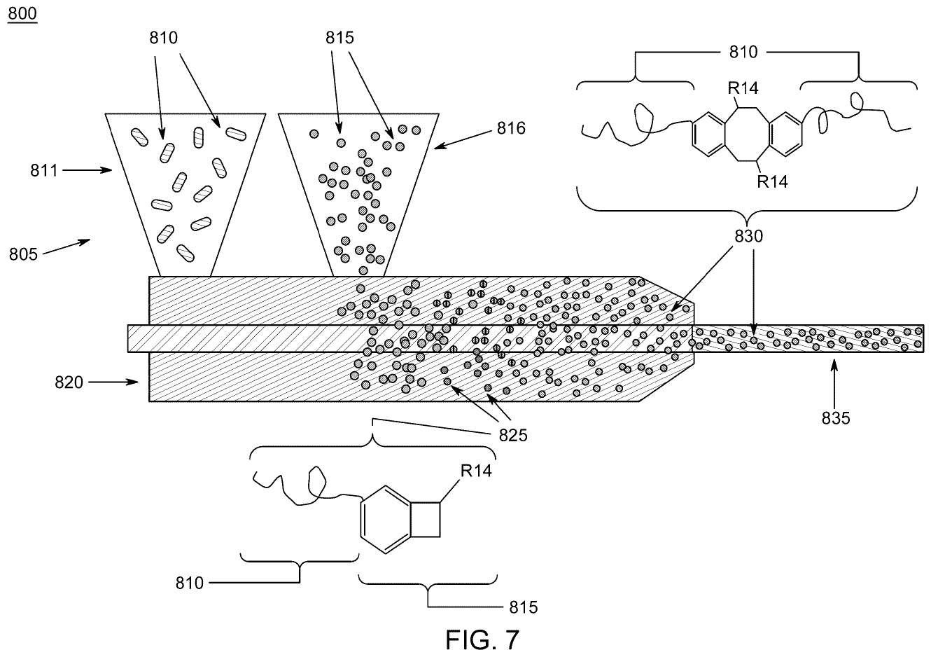

FIG. 7 is a schematic of an exemplary polymerization process in a method for synthesizing a DBCO-based low-CTE additive from BCBs. In this polymerization process 800, a host polymer 810 is housed in a first hopper 811 of a heated extruder 805, and a BCB precursor 815 is housed in a second hopper 816 of the heated extruder. The BCB precursor 815 comprises a R14 substituent that enables a lower dimerization temperature, as discussed herein. The BCB precursor 815 further comprises a reactive moiety at R15 on the benzene ring. The host polymer 810 and the BCB precursor 815 are then fed into a reaction vessel 820 in the heated extruder 805. In the reaction vessel 820, the host polymer 810 is incorporated into the BCB precursor 815 via the reactive moiety at R15 to generate a BCB-polymer intermediate 825. The BCB-polymer intermediate 825 then undergoes a dimerization reaction in situ in the heated extruder to produce a DBCO-based low-CTE additive 830, which includes two polymer moieties and two R14 moieties. The DBCO-based low-CTE additive 830 is then extruded from the heated extruder 805 through a die 835. In an alternative embodiment, the dimerization reaction produces a DBCO-based low-CTE additive with two R14 moieties and no polymer moieties (i.e., a molecule having structure (I), shown above, in which R1-R8 are all oxygen, one of R9 and R10 are not hydrogen, and one of R11 and R12 are not hydrogen).

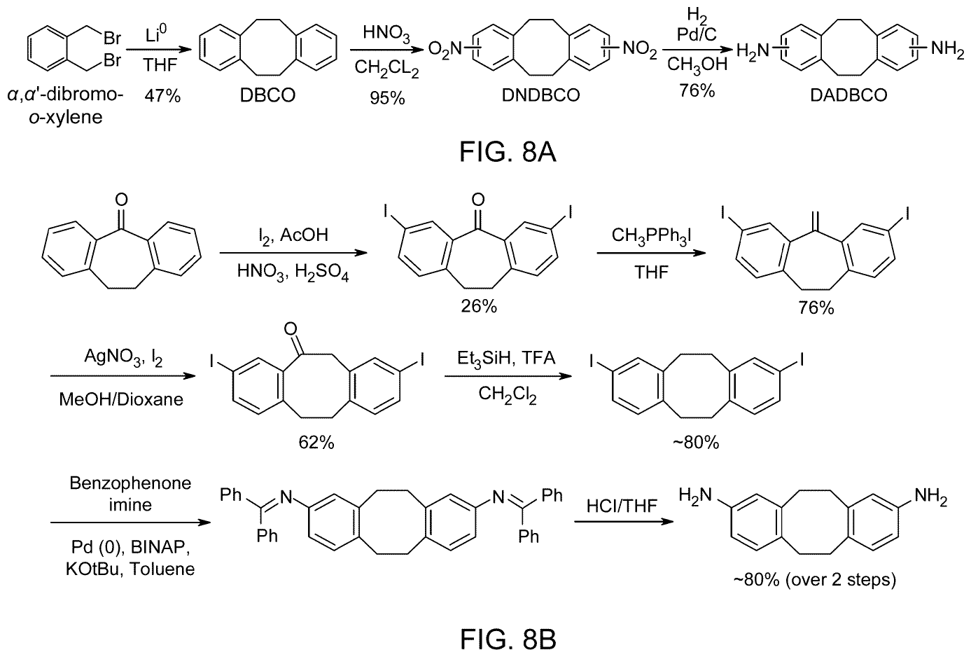

In aspects, DBCOs can be prepared from alternatives to BCBs. For example, FIG. 8A shows a process for synthesizing DADBCO from α,α′-dibromo-o-xylene. In the first step, α,α′-dibromo-o-xylene is dimerized in the presence of elemental Li to form a DBCO scaffold. See G. Franck et al., Org. Syn. 89, 55 (2012). Soft nitration of DBCO with excess HNO₃ in CH₂Cl₂ provides the dinitro derivative (DNDBCO). See A. G. Giumanini et al., Ind. Eng. Chem. Res. 41 (8), 1929 (2002). All six of the possible regioisomers can be obtained during the nitration step in approximately equal abundance (the ratio of ortho/meta nitro substituents was 2:3). In the final step, DNDBCO is hydrogenated under standard conditions to yield a mixture of DADBCO regioisomers. The trans- and cis-DADBCO regioisomers can be isolated from the DADBCO isomer mixture via exhaustive chromatography. FIG. 9 shows the thermodynamics of the twist-boat to chair transition for the m,m-cis regioisomer of DADBCO, in which the molecular volume decreases upon this isomerization when heat is added to the system.

Alternatively, the DADBCO regioisomer shown in FIG. 8B can be prepared in six steps from dibenzosuberone. The diiodination reaction and subsequent Wittig-Prevost ring expansion sequence on dibenzosuberone have been previously described by Kardelis et al. See V. Kardelis et al., Angew. Chem. Int. Ed. 55 (3), 945 (2016). Reduction of the ketone to the methylene in the ring expanded compound is accomplished using triethylsilane/trifluoracetic acid. Palladium catalyzed amination of the diiodinated DBCO with benzophenone imine followed by deprotection of the amine using HCl_{(aq)}/THF gives the DADBCO regioisomer as an off-white solid.

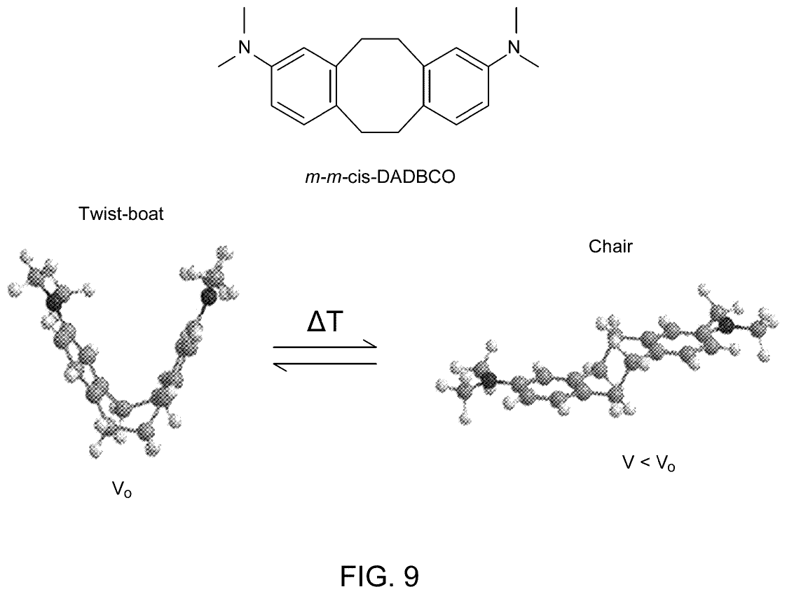

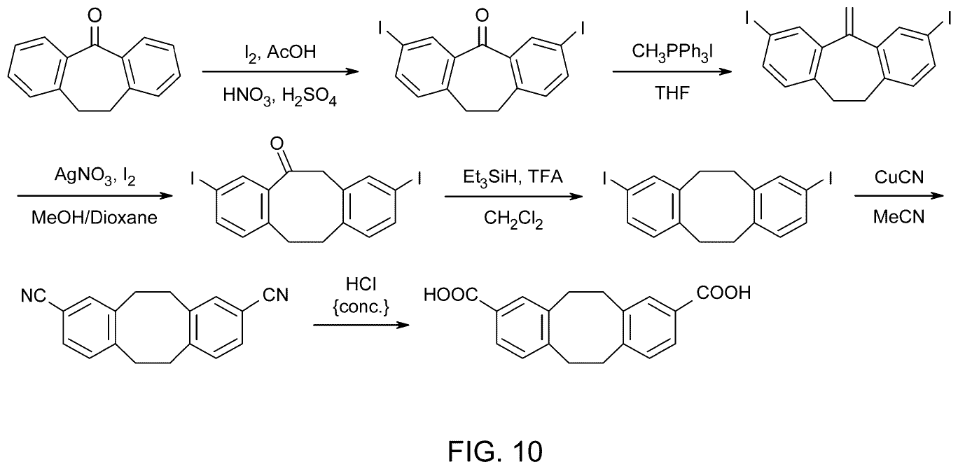

The dicarboxy-dibenzocyclooctene derivative shown in FIG. 10 can be prepared in six steps and shares the same di(iodobenzo)cyclooctene intermediate as in the DADBCO regioisomer synthesis described above for FIG. 8B. Di(iodobenzo)cyclooctene may be reacted with copper(I) cyanide in acetonitrile to give the dinitrile intermediate. Hydrolysis of the dinitrile intermediate with HCl_{(aq)} gives the dicarboxy-dibenzocyclooctene monomer.

FIG. 2A shows an exemplary synthetic route to prepare dihydroxy- and diazido-DBCOs. In this scheme, diamino-DBCO is reacted with sodium nitrite in hydrochloric acid to form a diazo compound in situ. Addition of sodium azide to the diazo compound yields the diazido-DBCO. Addition of water to the diazo compound yields a diphenol.

FIG. 2B shows an exemplary synthetic route to prepare dicarboxylic-acid-substituted DBCO and dianhydride-DBCO. Formylation of DBCO using dichloromethyl methyl ether and tin (IV) chloride yields a dialdehyde. Oxidation of the dialdehyde with potassium permanganate yields the dicarboxcylic-acid-substituted DBCO. The dicarboxcylic-acid-substituted DBCO can be acylated with chloroacetone to give the dianhydride-DBCO.

The phenyl rings of a monosubstituted or disubstituted DBCO can be further substituted with one or more alkyl groups such that the molecule can still undergo reversible twist-boat to chair isomerization. FIG. 2C shows an exemplary ortho-ortho-cis diamino version of tetramethylated DBCO.

Methods of Preparing Dibenzo-1,4-dioxocane Molecules

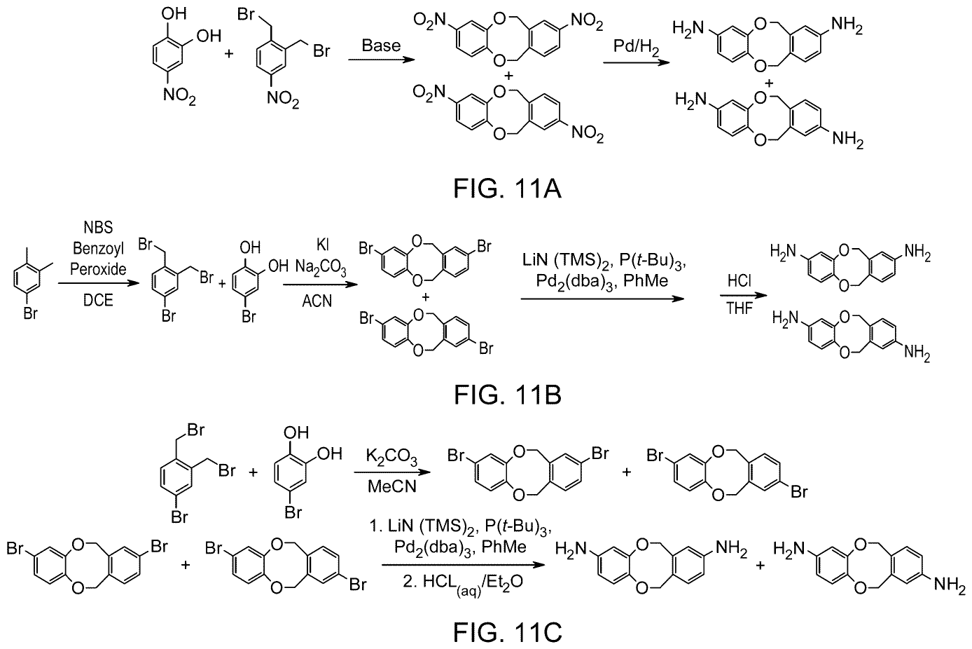

FIG. 11A shows an exemplary synthesis of 2,2′-diamino-dibenzo[b,f][1,4]dioxocin and 2,3′-diamino-dibenzo[b,f][1,4]dioxocin. This synthesis begins with the base promoted reaction of 4-nitrocatechol with 2-bromo-1-(bromomethyl)-4-nitrobenzene to give the cyclized diethers. Reduction of the nitro groups using H₂ and Pd/C gives 2,2′-diamino-dibenzo[b,f][1,4]dioxocin and 2,3′-dimethyl-dibenzo[b,f][1,4]dioxocin.

FIG. 11B illustrates an alternative synthesis of 2,2′-diamino-dibenzo[b,f][1,4]dioxocin and 2,3′-diamino-dibenzo[b,f][1,4]dioxocin. In the first step, 4-bromo-o-xylene undergoes allylic bromination and aromatic substitution at the methyl moieties by the addition of NBS, benzoyl peroxide, and DCE to produce 1,2-bis(bromomethyl)-4-bromobenzene and 4-bromocatechol. These intermediates are then combined with potassium iodide, sodium carbonate, and acetonitrile to produce di-bromine cyclized diethers. These cyclized di-ethers are then reacted with LiN(TMS)₂, tri-t-butylphosphine, tris(dibenzylideneacetone)dipalladium(0), and toluene. Hydrochloric acid and tetrahydrofuran are then added to produce 2,2′-diamino-dibenzo[b,f][1,4]dioxocin and 2,3′-dimethyl-dibenzo[b,f][1,4]dioxocin.

FIG. 11C illustrates another method of synthesis of 2,2′-diamino-dibenzo[b,f][1,4]dioxocin and 2,3′-diamino-dibenzo[b,f][1,4]dioxocin. The first step entails a reaction of 1,2-bis(bromomethyl)-4-bromobenzene and 4-bromocatechol with potassium carbonate and acetonitrile to produce di-bromine cyclized diethers. These cyclized di-ethers are then reacted with LiN(TMS)2, tri-t-butylphosphine, tris(dibenzylideneacetone)dipalladium(0), and toluene. Subsequently, aqueous hydrochloric acid and diethyl ether are added to the reaction mixture. As a result, 2,2′-diamino-dibenzo[b,f][1,4]dioxocin and 2,3′-diamino-dibenzo[b,f][1,4]dioxocin are produced.

Some reactions for producing dibenzo-1,4-dioxocanes have very low yield at atmospheric pressure and thus require high pressure in the reaction vessel to enable faster reactions to increase yield. Further, some reactions for producing dibenzo-1,4-dioxocanes involve separation of brominated products, which requires multiple recrystallizations. The exemplary synthetic processes illustrated in FIGS. 11A-11C are high yielding at atmospheric pressure, which means they do not require a special, pressurized reaction vessel. Further, the exemplary processes for producing dibenzo-1,4-dioxocanes disclosed herein do not require separation of brominated products. As such, the exemplary processes for producing dibenzo-1,4-dioxocanes disclosed herein may be less costly, faster, and require less steps and specialized equipment than other methods for synthesizing dibenzo-1,4-dioxocanes.

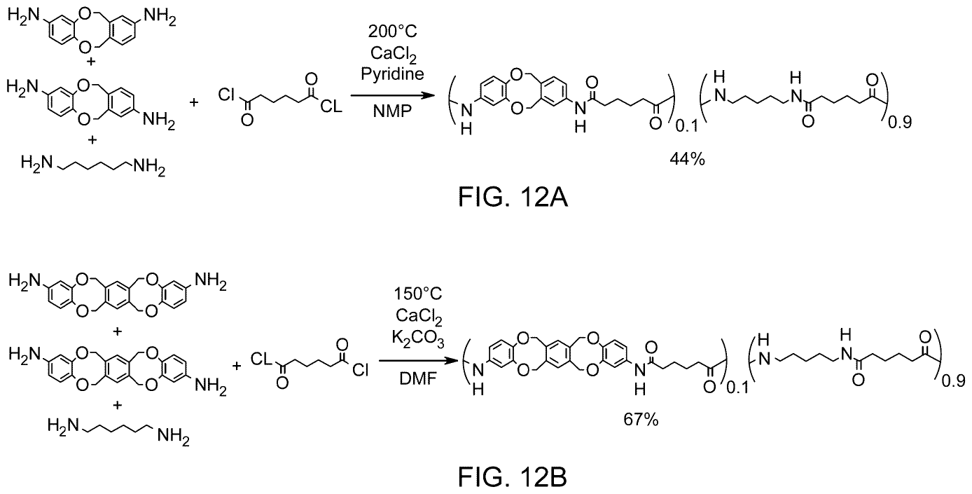

FIG. 12A is an illustration of a method to synthesize polyamide-substituted dibenzo[b,f][1,4]dioxocane. The exemplary reaction in FIG. 12A involves combination of 2,2′-diamino-dibenzo[b,f][1,4]dioxocin, 2,3′-diamino-dibenzo[b,f][1,4]dioxocin, hexamethylenediamine, and adipoyl chloride with calcium chloride, pyridine, and N-methylpyrrolidone at 200° C. This reaction produces 2,2′-bis(polyamide)-dibenzo[b,f][1,4]dioxocin and 2,3′-bis(polyamide)-dibenzo[b,f][1,4]dioxocin, wherein the dioxy-material comprises 10 wt. % of the polyamide.

### Methods of Preparing Bisdibenzo-1,4-Dioxocane Molecules

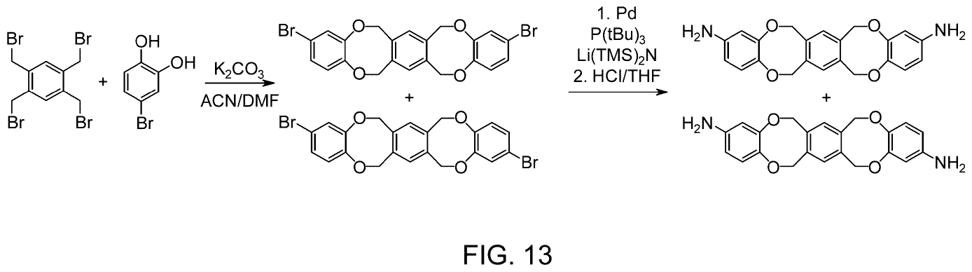

FIG. 13 shows an exemplary synthesis of 2,2′-diamino-bisdibenzo[b,f][1,4]dioxocane and 2,3′-diamino-bisdibenzo[b,f][1,4]dioxocane. In the first step, 4-bromocatechol and 1,2,4,5-tetra(bromomethyl)benzene are reacted with potassium carbonate, acetonitrile, and dimethylformamide to generate 2,2′-dibromo-bisdibenzo[b,f][1,4]dioxocane and 2,3′-dibromo-bisdibenzo[b,f][1,4]dioxocane. Next, palladium, lithium bis(trimethylsilyl)amide, and tri-tert-butylphosphine are mixed with the dibromo-bisdibenzo-1,4-dioxocanes. Subsequently, hydrochloric acid and tetrahydrofuran are added to the reaction mixture to hydrolyze the trimethylsilane protecting groups from the amine. As a result of these final two reaction steps, 2,2′-diamino-bisdibenzo-1,4-dioxocane and 2,3′-diamino-bisdibenzo-1,4-dioxocane are formed.

FIG. 12B is an illustration of a method to synthesize polyamide-substituted bisdibenzo[b,f][1,4]dioxocane. This reaction involves combination of 2,2′-diamino-bisdibenzo[b,f][1,4]dioxocane, 2,3′-diamino-bisdibenzo[b,f][1,4]dioxocane, hexamethylenediamine, and adipoyl chloride with calcium chloride, potassium carbonate, and dimethylformamide at 150° C. This reaction produces 2,2′-dipolyamide-bisdibenzo[b,f][1,4]dioxocane and 2,3′-dipolyamide-bisdibenzo[b,f][1,4]dioxocane, wherein the dioxy-material comprises 10 wt. % of the product and the polyamide comprises 90 wt. % of the product.

### Methods of Preparing Polymer Compositions

In aspects, the present disclosure is directed to a method of preparing a polymer composition comprising blending a thermoset or thermoplastic polymer with a thermally contractile heterocyclic organic molecule (e.g., molecules I-III) having a CTE that is less than a coefficient of thermal expansion of the thermoset or thermoplastic polymer. The blending of the thermoset or thermoplastic polymer with the additive can be accomplished, for example, using a solvent blending method, extruding, heated extrusion, melt blending, or roll milling.

In aspects, the blending of the thermoset or thermoplastic polymer with the additive results in at least one of the substituents of the additive becoming entangled with the thermoset or thermoplastic polymer. In some such aspects, at least one of the substituents on the additive has an entanglement weight that is within ±20% of an entanglement weight of the thermoset or thermoplastic polymer. For example, the entanglement weight of the substituent may be within ±20%, ±10%, ±5%, or even ±1% of the entanglement weight of the thermoset or thermoplastic polymer. In aspects, at least one of the substituents on the additive is configured to hydrogen bond with the thermoset or thermoplastic polymer.

Although it should be appreciated that various additives disclosed herein may be combined with various thermoset or thermoplastic polymers, in aspects, substitution of the additive molecule may provide a compatibility with particular thermoset or thermoplastic polymers. For example, at least one of the substituents on the additive may be selected from the group consisting of a polystyrene, a polyolefin, a polyurethane, a polyester, a polyamide, a polyimide, and a polyepoxide. In instances in which the additive has multiple substituents selected from the group consisting of a polystyrene, a polyolefin, a polyurethane, a polyester, a polyamide, a polyimide, and a polyepoxide, the substituents may be the same type (e.g., both polystyrenes or both polyesters), or they may be different types (e.g., one is a polyester and one is a polyamide or one is a polyurethane and one is a polyamide). In aspects, at least one of the substituents on the additive is the same moiety as the host polymer chain of the thermoset or thermoplastic polymer.

Although any methods and materials similar or equivalent to those described herein can be used in the practice or testing of the present disclosure, the preferred methods and materials are described. Other features, objects, and advantages of the present disclosure will be apparent from the description and the claims. In the specification and the appended claims, the singular forms include plural referents unless the context clearly dictates otherwise. Unless defined otherwise, all technical and scientific terms used herein have the same meaning as commonly understood by one of ordinary skill in the art to which this disclosure belongs. All references cited herein are incorporated herein by reference in their entirety and for all purposes to the same extent as if each individual publication, patent, or patent application was specifically and individually indicated to be incorporated by reference in its entirety for all purposes.

### EXAMPLES

The following examples are included for the purposes of illustration and does not limit the scope of the general inventive concepts described herein.

### Example 1: BCB Dimerization to Produce DBCO

In absence of dienophile, BCB can be converted to its dimer, DBCO, such as is shown in FIG. 4A. However, this requires high temperatures of approximately 200° C. and demonstrates a low dimer yield due to generation of various unidentified oligomeric products. Reducing the curing temperature and increasing the yield will allow for simpler and more easily scalable synthesis of DBCO.

Reduced cure temperatures were achieved by adding substituents to the 7 position in the four-membered ring (e.g., at R14) of BCB, as shown is FIGS. 4B and 4C. Commercially available 7-substitued BCBs with the following substituents were tested: a primary amine (NH₂), an alcohol (OH), a secondary amide (NH(C═O)R′), a ketone (C═O), and a methyl (CH₂) substituent at R14, as compared to the unsubstituted (i.e., R14=H) BCB. All of the 7-substituted BCBs required lower curing temperatures than unsubstituted BCB, as shown in Table 1 below.

TABLE 1
Curing Temperatures for Various 7-Substituted BCBs

| Substituent (R14) | NH2 | OH | NH(C═O)R′ | C═O | CH2 | H |
|---|---|---|---|---|---|---|
| Curing Temp. (° C.) | 25 | 80 | 111 | 150 | 180 | 200 |

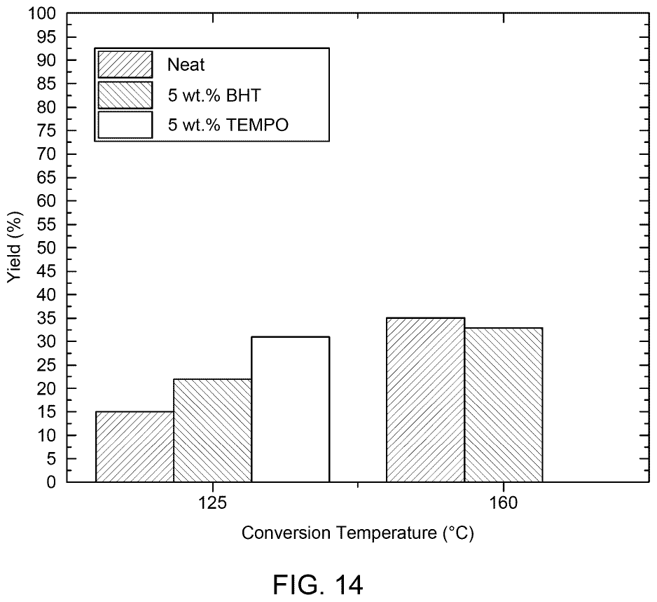

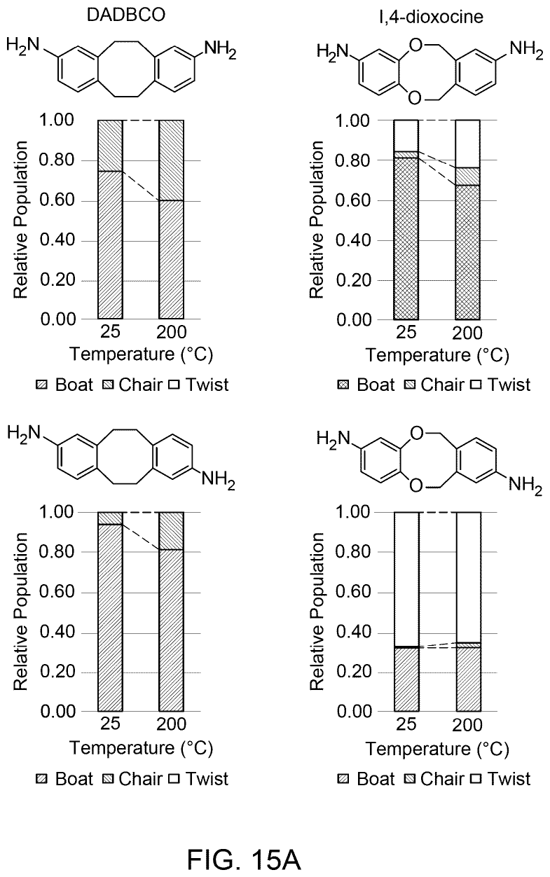

Radical polymerization inhibitors were used in an attempt to increase DBCO yield. Particularly, 5 wt. % of a radical polymerization inhibitor (either TEMPO or BHT) were added to the reaction mixture for dimerization of BCB-OH at a conversion temperature of either 125° C. or 160° C., and the yield of DBCO was measured. The results, as shown in FIG. 14, demonstrate an increase in DBCO yield percent when either of the radical polymerization inhibitors were included in the dimerization reaction mixture, as compared to the control with no radical polymerization inhibitor.

### Example 2: Modeling of Heterocyclic Molecule Conformations at Low and High Temperatures

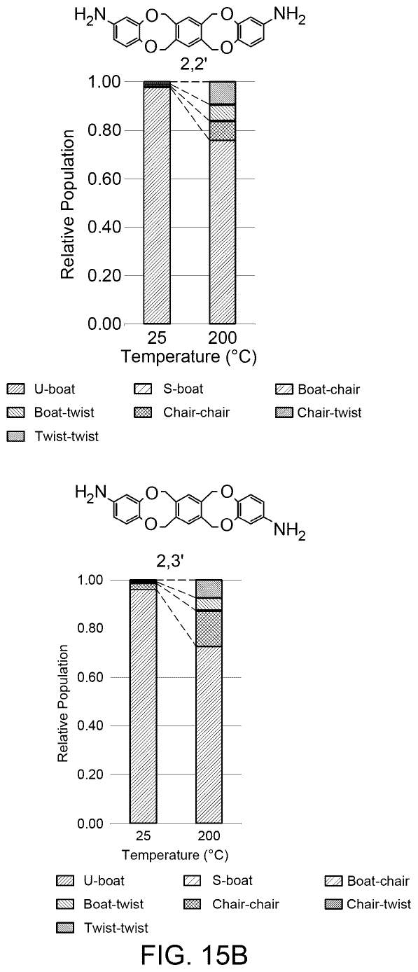

The relative populations (at 25° C. versus 200° C.) of structural isomers for various diamine DBCOs and 1,4-dioxocines in an epoxy resin were modeled using wB9M-D4 functional geometries and DLPNO-CCSD(T) single point energies to predict the thermodynamic and volume changes of these heterocyclic molecules at 25° C. as compared to 200° C. wB97M-D4 calculations used the ma-def2-TZP basis set, while the DLPNO-CCSD (T) calculations used a 3,4 extrapolation scheme to the complete basis set limit using cc-pVTZ and cc-pVQZ. The results are shown in FIG. 15A and Table 2 (below).

TABLE 2
Modeling of the Relative Populations of Structural
Isomers at 25° C. versus 200° C.

| Conformation | DADBCO | 1,4-Dioxocine |
|---|---|---|
| 2-2′-boat | −0.13 | −0.15 |
| 2-2′-chair | 0.13 | 0.08 |
| 2-2′-twist | 0.00 | 0.08 |
| 2-3′-boat | −0.13 | −0.14 |
| 2-3′-chair | 0.12 | 0.04 |
| 2-3′-twist | 0.01 | 0.10 |

As demonstrated by the results, DADBCO and 2,2′-diamino-1,4-dioxocine were predicted to have a higher proportion of lower volume conformations (i.e., chair and twist) at 200° C. than the lower temperature.

The conformational changes of 1,4-bisdiaminodibenzo-1,4-dioxocanes were also modeled in an epoxy resin to predict the thermodynamic and volume changes of these molecules at 25° C. and 200° C. The model used includes the resultant diols produced from the complete reaction of each amine with two epoxides. The two lowest energy (i.e., most stable) rotomers that correspond to same side and cross-central-ring hydrogen bonding were taken into account for each conformer (e.g., boat, chair, and twist) for a total of six rotomer/conformer combinations. The populations were calculated by a Boltzmann distribution across the six states and the populations of each rotomer summed together for each conformer, respectively. The results are shown in FIG. 15B. Both 2,2′- and 2,3′-bisdiaminodibenzo-1,4-dioxocane were predicted to have a higher proportion of lower volume conformations at 200° C. than the lower temperature.

What has been described above includes examples of one or more aspects. It is, of course, not possible to describe every conceivable modification and alteration of the above compositions or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A polymer composition comprising:
a thermoset or thermoplastic polymer; and
an additive comprising a molecule having a structure selected from the group consisting of: 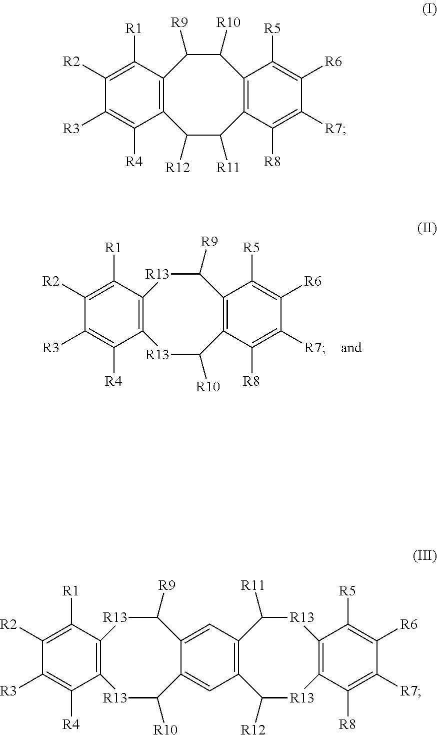
wherein R13 is selected from the group consisting of oxygen, nitrogen, and sulfur;
wherein at least three of R1, R2, R3, and R4 are hydrogen;
wherein at least three of R5, R6, R7, and R8 are hydrogen; and
wherein the polymer composition has a coefficient of thermal expansion (CTE) that is less than a coefficient of thermal expansion of the thermoset or thermoplastic polymer.

2. The polymer composition of claim 1, wherein one of R1, R2, R3, or R4 is not hydrogen, and one of R5, R6, R7, or R8 is not hydrogen.

3. The polymer composition of claim 1, wherein each of R9, R10, R11, and R12 is hydrogen.

4. The polymer composition of claim 1, wherein at least one of R9, R10, R11, or R12 is not hydrogen.

5. The polymer composition of claim 1, wherein R13 is oxygen.

6. The polymer composition of claim 1, wherein the additive comprises a monosubstituted- or di-substituted-dibenzocylooctane.

7. The polymer composition of claim 1, wherein the additive comprises a monosubstituted- or disubstituted-dibenzo-1,4-dioxocane.

8. The polymer composition of claim 1, wherein the additive comprises a monosubstituted- or disubstituted-bisdibenzo-1,4-dioxocane.

9. The polymer composition of claim 1, wherein one or more of: (1) R1, R2, R3, or R4 and (2) R5, R6, R7, or R8 of the additive is entangled with the thermoset or thermoplastic polymer.

10. The polymer composition of claim 1, wherein the additive is present in an amount of from about 5 wt. % to about 50 wt. %, based on the total weight of the polymer composition.

11. The polymer composition of any one of claim 1, wherein one or more of: (1) R1, R2, R3, or R4 and (2) R5, R6, R7, or R8 is selected from the group consisting of a polystyrene, a polyolefin, a polyurethane, a polyester, a polyamide, a polyimide, and a polyepoxide.

12. A method of preparing a polymer composition comprising:
blending a thermoset or thermoplastic polymer with an additive having a low or negative coefficient of thermal expansion (CTE), wherein the additive comprises a molecule having a structure selected from the group consisting of: 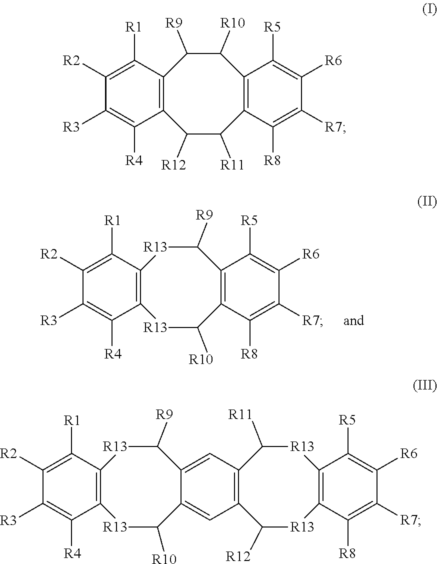
wherein R13 is selected from the group consisting of oxygen, nitrogen, and sulfur;
wherein at least three of R1, R2, R3, and R4 are hydrogen; and
wherein at least three of R5, R6, R7, and R8 are hydrogen.

13. The method of claim 12, wherein the blending comprises using a solvent blending method.

14. The method of claim 12, wherein the blending comprises extruding, heated extrusion, melt blending, or roll milling.

15. The method of claim 12, wherein one of R1, R2, R3, or R4 is not hydrogen, and one of R5, R6, R7, or R8 is not hydrogen.

16. The method of claim 12, wherein each of R9, R10, R11, and R12 is hydrogen.

17. The method of claim 12, wherein at least one of R9, R10, R11, or R12 is not hydrogen.

18. The method of claim 12, wherein R13 is oxygen.

19. The method of claim 12, wherein the additive comprises a monosubstituted- or disubstituted-dibenzocylooctane.

20. The method of claim 19, wherein the blending comprises adding to the thermoset or thermoplastic polymer a precursor of the additive, wherein the precursor dimerizes during the blending to form the additive.

21. The method of claim 20, wherein the precursor comprises a substituted benzocylcobutene.

22. The method of claim 12, wherein the additive comprises a monosubstituted- or disubstituted-dibenzo-1,4-dioxocane.

23. The method of claim 12, wherein the additive comprises a monosubstituted- or disubstituted-bisdibenzo-1,4-dioxocane.

24. The method of claim 12, wherein one or more of: (1) R1, R2, R3, or R4 and (2) R5, R6, R7, or R8 of the additive is entangled with the thermoset or thermoplastic polymer.

25. The method of claim 12, wherein the additive is present in an amount of from about 5 wt. % to about 50 wt. %, based on the total weight of the polymer composition.

26. The method of claim 12, wherein at least one of: (1) R1, R2, R3, or R4 and (2) R5, R6, R7, or R8 has an entanglement weight that is within ±10% of an entanglement weight of the thermoset or thermoplastic polymer.

27. The method of claim 12, wherein at least one of: (1) R1, R2, R3, or R4 and (2) R5, R6, R7, or R8 is selected from the group consisting of a polystyrene, a polyolefin, a polyurethane, a polyester, a polyamide, a polyimide, and a polyepoxide.
